(19) United States
(12) Patent Application Publication
(10) Pub. No.: US 2025/0076667 A1
(43) Pub. Date: Mar. 6, 2025

(54) SUPPORT FOR HEAD-MOUNTABLE DEVICE

(71) Applicant: Apple Inc., Cupertino, CA (US)

(72) Inventors: Brian P. GORMLEY, Santa Clara, CA (US); Amy R. KAWABATA, Walnut Creek, CA (US); Bryan A. AGUIRRE, San Jose, CA (US); Justin R. LEES, Bloomington, MN (US)

(21) Appl. No.: 18/791,098

(22) Filed: Jul. 31, 2024

Related U.S. Application Data
(60) Provisional application No. 63/535,974, filed on Aug. 31, 2023.
(60) Provisional application No. 63/633,569, filed on Apr. 12, 2024.

(51) Int. Cl. G02B 27/01

(52) U.S. Cl. CPC G02B 27/0176; G02B 2027/014; G02B 2027/0152; G02B 2027/0198

(57) ABSTRACT

Systems and devices of the present disclosure can include stabilization features that support the head-mountable device to both facilitate and enhance movement during capture. The systems can include a case that engages the head-mountable device and provides a view to an external environment. The support provided by the system can provide the user wearing the head-mountable device with a wide range of movement (e.g., pan and tilt) while also guiding movement within the range.

### CROSS REFERENCE TO RELATED APPLICATIONS

The present application claims the benefit of U.S. Provisional Application No. 63/535,974, entitled “Support For Head-Mountable Device,” filed Aug. 31, 2023, and U.S. Provisional Application No. 63/633,569, entitled “Support For Head-Mountable Device,” filed Apr. 12, 2024, the entirety of which are incorporated herein by reference.

### TECHNICAL FIELD

The present description relates generally to head-mountable devices, and, more particularly, to systems for supporting head-mountable devices.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include audio output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1A illustrates a perspective view of a system for stabilizing a head-mountable device, in accordance with embodiments of the present disclosure.

FIG. 1B illustrates a perspective view of a portion of a system for stabilizing a head-mountable device, in accordance with embodiments of the present disclosure.

FIG. 1C illustrates a perspective view of a portion of a system for stabilizing a head-mountable device, in accordance with embodiments of the present disclosure.

FIG. 2 illustrates a top view of a head-mountable device, in accordance with embodiments of the present disclosure.

FIG. 3 illustrates a front view of the head-mountable device of FIG. 2, in accordance with embodiments of the present disclosure.

FIG. 4 illustrates a top view of a case, in accordance with embodiments of the present disclosure.

FIG. 5 illustrates a front view of the case of FIG. 4, in accordance with embodiments of the present disclosure.

FIG. 6 illustrates a side view of a head-mountable device and a case in a separated configuration, in accordance with embodiments of the present disclosure.

FIG. 7 illustrates a side view of the head-mountable device and the case of FIG. 6 with the case receiving the head-mountable device, in accordance with embodiments of the present disclosure.

FIG. 8 illustrates a side view of a head-mountable device and a case in a separated configuration, in accordance with embodiments of the present disclosure.

FIG. 9 illustrates a side view of the head-mountable device and the case of FIG. 8 with the case receiving the head-mountable device, in accordance with embodiments of the present disclosure.

FIG. 10 illustrates a top view of a head-mountable device and a case, in accordance with embodiments of the present disclosure.

FIG. 11 illustrates a front view of the head-mountable device and the case of FIG. 10, in accordance with embodiments of the present disclosure.

FIG. 12 illustrates a perspective view of a system for stabilizing a head-mountable device, in accordance with embodiments of the present disclosure.

FIG. 13 illustrates a block diagram of a head-mountable device and an accessory device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device. A head-mountable device can be used to capture, create, and edit media, for example, by capturing images, recording audio, and the like. Such capturing and recording operations can be performed while the head-mountable device is worn by a user. This can allow the user to determine the field of view for capture by moving naturally while wearing the head-mountable device. Where such capturing and recording operations generate media, the media can be reviewed in a playback operation. This can be done on the same or a different electronic device. Accordingly, the captured and recorded images and/or audio can be experienced by others at a later time.

Where capture is performed while a head-mountable device is worn by a user, the movements of the user can determine the field of view captured by the head-mountable device. It can be desirable to provide mechanisms to support, guide, and/or enhance movement of the user and the head-mountable device during capture so that the recorded media has the desired features upon playback.

Systems and devices of the present disclosure can include stabilization features that support the head-mountable device to both facilitate and enhance movement during capture. The systems can include a case that engages the head-mountable device and provides a view to an external environment. The support provided by the system can provide the user wearing the head-mountable device with a wide range of movement (e.g., pan and tilt) while also guiding movement within the range.

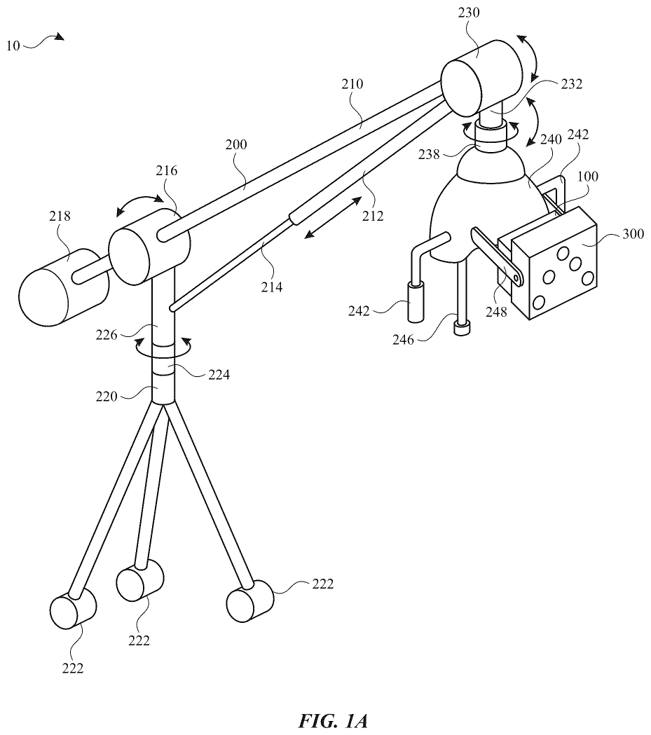

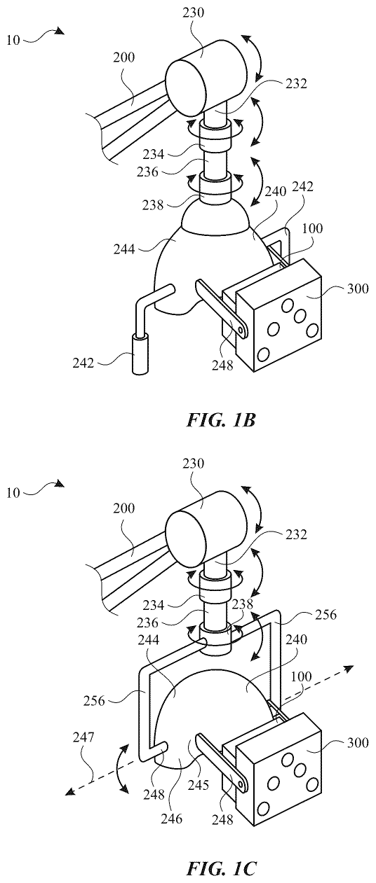

These and other embodiments are discussed below with reference to FIGS. 1-13. However, those skilled in the art will readily appreciate that the detailed description given herein with respect to these Figures is for explanatory purposes only and should not be construed as limiting.

Referring now to FIGS. 1A-1C, a system can be provided to stabilize a head-mountable device and guide movements thereof for enhanced capture operations. Such a system 10 can be securely and releasably coupled to a head-mountable device 100 such that, while the head-mountable device 100 is used with the system, the head-mountable device 100 moves with one or more components of the system 10.

As shown in FIG. 1A, the system 10 can include a base 220 for supporting one or more other components of the system 10. The base 220 can include one or more wheels 222 to facilitate movement of the system 10 with respect to one or more surfaces. As such, the system 10 as a whole can move as desired based on movement of a user. For example, the wheels 222 can facilitate movement in response to an applied force, such as at or near the head-mountable device 100. By further example, the wheels 222 can effect movement by applying a force, such as in response to a control signal. It will be understood that the base 220 can omit wheels 222 and/or include one or more other components, such as mounts to couple to one or more other structures. In some embodiments, the base 220 can be securely coupled to a stationary object, such that movement of the head-mountable device 100 is limited to a range provided by other components of the system 10.

As further shown in FIG. 1A, the system 10 can include a post 226. The post 226 can be rotatably coupled to the base 220 by a post pivot 224. The post pivot 224 can facilitate rotation of the post 226 with respect to the base 220 in one or more axes. For example, the post pivot 224 can facilitate rotation in a yaw axis. By further example, the post pivot 224 can include a ball joint or other mechanism that facilitates multi-axial rotation. The post pivot 224 can include one or more locks (e.g., locking pin, ball lock knob, etc.) that, when engaged, limit or prevent rotation. The post pivot 224 can include one or more mechanisms, such as a fluid head, for allowing rotation about its axis at a limited rate. As used herein, a fluid head is a joint between moving (e.g., rotating) parts that dampens movement with a sealed container (e.g., cartridge) of a fluid by creating drag as components move through the fluid.

As further shown in FIG. 1A, the system 10 can include a boom 200. The boom 200 can be rotatably coupled to the post 226 and/or the base 220 by a boom pivot 216. The boom pivot 216 can facilitate rotation of the boom 200 with respect to the post 226 and/or the base 220 in one or more axes. For example, the boom pivot 216 can facilitate rotation in a pitch axis. The axis of rotation provided by the boom pivot 216 can be different than (e.g., orthogonal to) that of the post pivot 224. By further example, the boom pivot 216 can include a ball joint or other mechanism that facilitates multi-axial rotation. The boom pivot 216 can include one or more locks (e.g., locking pin, ball lock knob, etc.) that, when engaged, limit or prevent rotation. The boom pivot 216 can include one or more mechanisms, such as a fluid head, for allowing rotation about its axis at a limited rate.

The boom 200 can include an arm 210 that extends from the boom pivot 216 toward an extension pivot 230 and/or another component of the system 10. Rotation of the boom 200 about the boom pivot 216 can be facilitated by one or more supports, such as a first section 212 and a second section 214. As shown in FIG. 1A, the first section 212 can extend from the extension pivot 230 and/or another component of the system 10, and the second section 214 can extend from the post 226. The first section 212 and/or the second section 214 can move relative to each other to adjust a combined length (e.g., between the post 226 and the extension pivot 230 and/or another component of the system 10. The first section 212 and/or the second section 214 can include one or more locks (e.g., locking pin, etc.) that, when engaged, limit or prevent relative movement there between. The first section 212 and/or the second section 214 can include one or more mechanisms, such as a fluid head, for allowing relative motions there between at a limited rate.

The boom 200 can extend with an arm 210 in one direction from the boom pivot 216, and a counterweight 218 can extend in a different (e.g., opposite) direction from the boom pivot 216. The counterweight 218 can be selected to substantially balance components of the boom 200 on opposing sides of the boom pivot 216. This can include the head-mountable device 100 and other components of the system 10. As such, boom 200 can be balanced across the boom pivot 216, and the head-mountable device 100 can remain stationary in the absence of an applied force (e.g., by a user). Furthermore, the head-mountable device 100 and other components of the system 10 can feel substantially or nearly weightless to a user wearing the head-mountable device 100.

As further shown in FIG. 1A, the system 10 can include an extension 232, for example as part of or coupled to the boom 200. The extension 232 can be rotatably coupled to the arm 210 by the extension pivot 230. The extension pivot 230 can facilitate rotation of the extension 232 with respect to the arm 210 in one or more axes. For example, the extension pivot 230 can facilitate rotation in a pitch axis. By further example, the extension pivot 230 can include a ball joint or other mechanism that facilitates multi-axial rotation (e.g., yaw, pitch, and/or roll). The extension pivot 230 can include one or more locks (e.g., locking pin, ball lock knob, etc.) that, when engaged, limit or prevent rotation. The extension pivot 230 can include one or more mechanisms, such as a fluid head, for allowing rotation about its axis at a limited rate.

As further shown in FIG. 1A, the system 10 can include a head engager 240, for example as part of or coupled to the boom 200. The head engager 240 can be rotatably coupled to the extension 232 by the head pivot 238. The head pivot 238 can facilitate rotation of the head engager 240 with respect to the extension 232 in one or more axes. For example, the head pivot 238 can include a ball joint or other mechanism that facilitates multi-axial rotation. The head pivot 238 can include one or more locks (e.g., locking pin, ball lock knob, etc.) that, when engaged, limit or prevent rotation. The head pivot 238 can include one or more mechanisms, such as a fluid head, for allowing rotation about its axis at a limited rate.

The head engager 240 can be provided to engage a head of a user wearing the head-mountable device. It will be understood that the head engager 240 can be optional, for example where another head engager is provided by the head-mountable device 100. Where the head engager 240 is omitted, a case 300 or another component can be directly coupled to other components of the system 10, such as the head pivot 238. The head engager 240 can include one or more features for securely and releasably engaging ahead of a user. For example, the head engager 240 can include one or more straps for extending about a portion of a head of a user. The head engager 240 can remain engaged with the head of the user wearing the head-mountable device. As such, movement of the head of the user in any direction can be transmitted as forces to other components of the system 10. Accordingly, the movable and/or rotatable components of the system 10 can accommodate such movement in response to applied forces at the head engager 240, the head-mountable device 100, and/or the case 300.

The system 10 can include a case 300 for releasably and securely engaging the head-mountable device 100. The head-mountable device 100 can be provided to the case 300 when the head-mountable device 100 is desired to be used with the system 10. The case 300 can provide one or more features for engaging and supporting operation of the head-mountable device 100, as described further herein.

The system 10 can include a coupler 248 configured to adjustably engage a case 300 with respect to one or more components of the system 10. For example, the coupler 248 of FIG. one is shown coupling the case 300 to the head engager 240. It will be understood that the coupler 248 can adjustably engage the case 300 with respect to other components of the system 10, such as any portion of the boom 200 or component coupled thereto. The coupler 248 can be adjusted to position the case 300 in a variety of positions and/or orientations with respect to other components of the system 10, such as the head engager 240.

The system 10 can include one or more handles 242 available for operation by a user wearing the head-mountable device 100. The handles 242 can extend on a corresponding side of the head-mountable device 100, such that the handles 242 do not interfere with a field of view of the head-mountable device 100. For example, the outer portion of the case 300 providing openings for the head-mountable device 100, can face away from the handles 242. By further example, the field of view of the head-mountable device 100, when received by the case 300, can face away from the handles 242. Handles 242 can extend from the head engager 240, the case 300, the extension 232, and/or one or more other components of the system 10, such as the boom 200.

The handles 242 can be rigidly coupled to the case 300 (e.g., via the coupler 248), such that movement by the user wearing the head-mountable device 100 can be supported by forces applied to the handles 242. As such, the intended movement can be achieved both by directly moving the head-mountable device 100 and the handles 242. This can help decouple the movement of the head (e.g., about the neck of the user) from the resulting movement of the head-mountable device 100.

It will be understood that the system said can include any number of components that are interconnected via one or more joints. While certain number of moving and rotating parts are illustrated in FIG. one, it will be understood that a variety of arrangements can be provided to enable a wide range of motions for a user wearing the head-mountable device 100. For example, additional pivots and/or joints can be provided for additional rotational abilities. By further example, additional arms and/or extensions can be provided for additional ranges of motion. As such, the system 10 is not limited by the components illustrated in FIG. 1A and described with respect thereto. Indeed, a case 300 can be coupled to one or more of a variety of systems to support a head-mountable device 100. It will be understood that different systems can be provided in different scenarios to provide a different range of capabilities.

Accordingly, the system 10 can enhance movement of the entire head-mountable device 100 during capture so that the recorded media provides the desired features upon playback. Such stabilization supports the head-mountable device 100 at the case 300 to both facilitate and enhance movement during capture. This can provide the user wearing the head-mountable device 100 with a wide range of movement (e.g., pan and tilt) while also guiding movement within the range.

Referring now to FIG. 1B, the system 10 can include any number of extensions and/or pivots to connect the boom 200 to the head engager 240, the head-mountable device 100, and/or the case 300. It will be understood that the system 10 shown in FIG. 1B can include any one or more of the features described herein with respect to the system 10 of FIG. 1A. In some embodiments, multiple extensions and/or pivots can be provided between the boom 200 and the head engager 240.

For example, as shown in FIG. 1B, a first extension 232 can be rotatably coupled to the boom 200 by the first extension pivot 230. The first extension pivot 230 can facilitate rotation of the first extension 232 with respect to the boom 200 in one or more axes. For example, the first extension pivot 230 can facilitate rotation in a pitch axis. By further example, the first extension pivot 230 can include a ball joint or other mechanism that facilitates multi-axial rotation (e.g., yaw, pitch, and/or roll). The first extension pivot 230 can include one or more locks (e.g., locking pin, ball lock knob, etc.) that, when engaged, limit or prevent rotation. The first extension pivot 230 can include one or more mechanisms, such as a fluid head, for allowing rotation about its axis at a limited rate.

As further shown in FIG. 1B, a second extension 236 can be rotatably coupled to the first extension 232 by a second extension pivot 234. The second extension pivot 234 can facilitate rotation of the second extension 236 with respect to the first extension 232 in one or more axes. For example, the second extension pivot 234 can facilitate rotation in a pitch axis. By further example, the second extension pivot 234 can include a ball joint or other mechanism that facilitates multi-axial rotation (e.g., yaw, pitch, and/or roll). The second extension pivot 234 can include one or more locks (e.g., locking pin, ball lock knob, etc.) that, when engaged, limit or prevent rotation. The second extension pivot 234 can include one or more mechanisms, such as a fluid head, for allowing rotation about its axis at a limited rate.

As further shown in FIG. 1B, the system 10 can include a head engager 240. The head engager 240 can be rotatably coupled to the second extension 236 by the head pivot 238. The head pivot 238 can facilitate rotation of the head engager 240 with respect to the second extension 236 in one or more axes. For example, the head pivot 238 can include a ball joint or other mechanism that facilitates multi-axial rotation. The head pivot 238 can include one or more locks (e.g., locking pin, ball lock knob, etc.) that, when engaged, limit or prevent rotation. The head pivot 238 can include one or more mechanisms, such as a fluid head, for allowing rotation about its axis at a limited rate. In some embodiments, the head pivot 238 can connect the second extension 236 to an upper portion 244 of the head engager 240. For example, the head pivot 238 can connect to the upper portion 244 at a side of the head engager 240 that is above the head-mountable device 100 and/or the case 300 while in an upright orientation.

By providing a greater number of extensions and/or pivots between the boom 200 and the head engager 240, the head-mountable device 100, and/or the case 300 can be moved in a variety of directions and across a range of motion while requiring less responsiveness from the boom 200 and/or other portions of the system 10. For example, the system 10 can provide a range of motion and/or rotation to the head engager 240, the head-mountable device 100, and/or the case 300 by allowing the first extension 232 and/or the second extension 236 to move and/or rotate with respect to each other, the boom 200, and/or the head engager 240. Accordingly, certain motions (e.g., within a range) can be provided apart from and/or without requiring corresponding movement by the boom 200. As such, the first extension 232 and/or the second extension 236 can provide highly responsive actions to provide greater case of movement at the head engager 240. Accordingly, the movable and/or rotatable components of the system 10 can accommodate such movement in response to applied forces at the head engager 240, the head-mountable device 100, and/or the case 300.

It will be understood that the system 10 can include and/or be connected to any number of extensions and corresponding pivots. For example, the system 10 can provide, between the boom 200 and the head engager 240, the head-mountable device 100, and/or the case 300, for example, 1, 2, 3, 4, 5, 6, or more than 6 extensions with corresponding pivots provided there between. Each pivot can provide relative rotation in one or more axes. Each of the extensions can have any selected length to provide the desired range of motion.

Referring now to FIG. 1C, the system 10 can include a connection to a head engager 240, a head-mountable device 100, and/or a case 300 that provides desired performance characteristics. It will be understood that the system 10 shown in FIG. 1C can include any one or more of the features described herein with respect to the system 10 of FIGS. 1A and/or 1B. In some embodiments, the system 10 can connect to the head engager 240 in a manner that facilitates natural head movements of the user and/or guides the user to particular types of motions.

For example, as shown in FIG. 1C, a first extension 232 can be rotatably coupled to the boom 200 by a first extension pivot 230, and/or a second extension 236 can be rotatably coupled to the first extension 232 by a second extension pivot 234, as discussed herein. In some embodiments, one or more arms 256 can be rotatably coupled to the first extension 232 and/or the second extension 236 by an arm pivot 239. The arm pivot 239 can facilitate rotation of the one or more arms 256 with respect to the first extension 232 and/or the second extension 236 in one or more axes. For example, the arm pivot 239 can facilitate rotation in a pitch axis (e.g., axis 247), which can optionally extend through each of multiple arm pivots 239, where applicable. By further example, the arm pivot 239 can include a ball joint or other mechanism that facilitates multi-axial rotation (e.g., yaw, pitch, and/or roll). The arm pivot 239 can include one or more locks (e.g., locking pin, ball lock knob, etc.) that, when engaged, limit or prevent rotation. The arm pivot 239 can include one or more mechanisms, such as a fluid head, for allowing rotation about its axis at a limited rate.

As further shown in FIG. 1C, the system 10 can include a head engager 240. The head engager 240 can be rotatably coupled to the one or more arms 256 by one or more head pivots 258. The one or more head pivots 258 can facilitate rotation of the head engager 240 with respect to the one or more arms 256 in one or more axes. For example, the one or more head pivots 258 can include a ball joint or other mechanism that facilitates multi-axial rotation. The one or more head pivots 258 can include one or more locks (e.g., locking pin, ball lock knob, etc.) that, when engaged, limit or prevent rotation. The one or more head pivots 258 can include one or more mechanisms, such as a fluid head, for allowing rotation about its axis at a limited rate.

In some embodiments, multiple arms 256 can be provided to extend from different portions and/or sides of the first extension pivot 230 and/or the second extension 236. The multiple arms 256 can also connect to different portions and/or sides of the head engager 240. For example, the multiple arms 256 can each connect to a different (e.g., opposite) lateral side of the head engager 240. By further example, a single arm 256 can connect to a side (e.g., a rear side) of the head engager 240.

In some embodiments, the one or more head pivots 258 can connect the one or more arms 256 to a lower portion 246 of the head engager 240. For example, the one or more head pivots 258 can connect to the lower portion 246 at a side of the head engager 240 that is below the head-mountable device 100 and/or the case 300 while in an upright orientation. By further example, the head-mountable device 100 and/or the case 300 can be positioned and/or connected to a middle portion 245 of the head engager 240, with the middle portion 245 being between the upper portion 244 and the lower portion 246. The lower portion 246 can be defined as being positioned within and/or intersecting a horizontal plane that extends below the head-mountable device 100 and/or the case 300. The lower portion 246 can also be defined as being positioned on a side of the head engager 240 that is opposite (e.g., facing away from) the boom 200 and/or other portions of the system 10. Providing the one or more head pivots 258 at the lower portion 246 can provide the head engager 240 with an axis of rotation that is closer to a neck of the user than would be provided at the upper portion 244. Accordingly, motions and/or rotations of the head engager 240 that are driven by the user pivoting the head with respect to the neck can be facilitated by the one or more head pivots 258 at the lower portion 246 of the head engager. By providing a rotational connection at such a location, the system 10 can provide a range of motion and/or rotation to the head engager 240, the head-mountable device 100, and/or the case 300 by allowing the head engager 240 to move with respect to the first extension 232, the second extension 236, and/or the boom 200. Accordingly, certain motions (e.g., within a range) can be provided apart from and/or without requiring corresponding movement by the first extension 232, the second extension 236, and/or the boom 200. As such, the head engager 240 can provide highly responsive actions to provide greater ease of movement for the user. Accordingly, the movable and/or rotatable components of the system 10 can accommodate such movement in response to applied forces at the head engager 240, the head-mountable device 100, and/or the case 300.

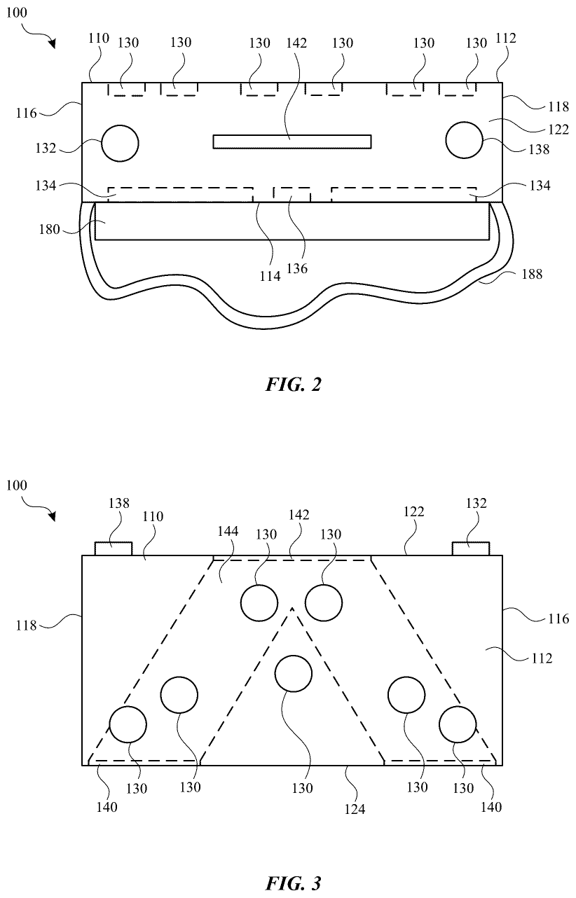

Referring now to FIGS. 2 and 3, a head-mountable device for use with a system of the present disclosure can provide features for use by a user.

According to some embodiments, for example as shown in FIGS. 2 and 3, a head-mountable device 100 can include a housing 110 that is worn on a head with a head engager 188. The housing 110 can be positioned in front of the eyes of a user to provide information within a field of view of the user. The housing 110 can provide nose pads or another feature to rest on a user's nose. The housing 110 further includes one or more displays 134 (e.g., one for each eye) and a bridge above the nose pads and connecting multiple displays 134. The head-mountable device 100 can include a sensor 130 for capturing a view of an environment external to the head-mountable device 100. The display 134 can provide visual (e.g., image or video) output based on the view captured by the sensor 130. For example, a display 134 can transmit light from or based on a physical environment for viewing by the user. Additionally or alternatively, a display 134 can provide information as a display within a field of view of the user. Displayed information can be provided to the exclusion of a view of a physical environment or in addition to (e.g., overlaid with) a physical environment.

The housing 110 can include and/or define an outer portion 112 and an inner portion 114, opposite the outer portion 112. As used herein, an outer portion 112 of a head-mountable device is a portion that faces away from the user and/or towards an external environment. As used herein, an inner portion of a head-mountable device is a portion that faces toward the user and/or away from the external environment. The housing 110 can further include and/or define a left portion 116 and a right portion 118, opposite the left portion 116. The housing 110 can further include and/or define a top portion 122 and a bottom portion 124, opposite the top portion 122. As used herein, the terms “left,” “right,” “top,” and “bottom” each refer to the perspective of the user while wearing and/or operating the head-mountable device 100. It will be understood that such portions need not be planar and need not be distinctly defined relative to each other by edges and/or corners. As such, any given portion can transition to an adjacent portion. It will be understood that, while the housing 110 is illustrated in FIGS. 2 and 3 with corners and edges, transitions from one portion to another may be gradual, curved, and the like. One or more features of the portions illustrated in FIGS. 2 and 3 may be provided at transitions between portions. Any number of portions can be provided. It will be recognized that opposing portions can allow a case to engage the housing 110 of the head-mountable device 100.

According to some embodiments, for example as shown in FIG. 2, the head-mountable device 100 can further include a face engager 180, which can be positioned on the inner portion 114 of the housing 110 to engage portions of the user's face, such as the forehead, cheeks, temples, and nose. While the face engager 180 is shown schematically with a particular size and shape, it will be understood that the size and shape of the face engager 180, particularly at its inner portion, can have a size and shape that accommodates the face of a user wearing the head-mountable device 100. For example, the face engager 180 can provide a shape that generally matches the contours of the user's face around the eyes of the user. The face engager 180 can provide one or more features that allow it to conform to the face of the user to enhance comfort and block light from entering the face engager 180 at the regions of contact with the face. For example, the face engager 180, or portions thereof, can provide a flexible, soft, elastic, and/or compliant structure.

As further shown in FIGS. 2 and 3, the housing 110 and/or the face engager 180 can be supported on a user's head with a head engager 188. The head engager 188 can wrap or extend along opposing sides of a user's head and/or to a rear of the user's head. The head engager 188 can optionally include earpieces for wrapping around or otherwise engaging or resting on a user's ears. It will be appreciated that other configurations can be applied for securing the head-mountable device 100 to a user's head. For example, one or more bands, straps, belts, caps, hats, or other components can be used in addition to or in place of the illustrated head engager 188 of the head-mountable device 100. The head engager 188 can optionally include a band for extending to and/or about a rear side of the head of the user. The head engager 188 can optionally extend from the housing 110 or another component coupled to the housing 110. For example, the head engager 188 can optionally extend from the face engager 180. The band or other structure can be stretchable to comfortably provide tension about the head of the user. The head engager can further include an adjustment element (not shown) for adjusting a tightness and/or fit of the head engager.

The head-mountable device 100 can include one or more sensors 130 for tracking features of or in an external environment. For example, the head-mountable device 100 can include cameras, image sensors, depth sensors, thermal (e.g., infrared) sensors, and the like. By further example, a depth sensor can be configured to measure a distance (e.g., range) to an object via stereo triangulation, structured light, time-of-flight, interferometry, and the like. Additionally or alternatively, sensors 130 can include or operate in concert with cameras to capture and/or process an image based on one or more of hue space, brightness, color space, luminosity, and the like. While sensors 130 are shown on the outer portion 112 of the housing 110, it will be understood that sensors 130 can additionally or alternatively be provided at any portion of the head-mountable device 100, such as the top portion 122, the bottom portion 124, the left portion 116, the right portion 118, and/or the inner portion 114.

The head-mountable device 100 can include one or more internal sensors 136 for tracking features of the user wearing the head-mountable device 100. For example, an internal sensor 136 can be a user sensor to perform facial feature detection, facial movement detection, facial recognition, eye tracking, user mood detection, user emotion detection, voice detection, etc. By further example, the internal sensor can be a bio-sensor for tracking biometric characteristics, such as health and activity metrics.

The head-mountable device 100 can include one or more input devices 132. For example, the input device 132 can include one or more buttons, crowns, keys, touch sensors, switches, cameras, optical sensors, magnetometers, dials, trackpads, microphones, and the like. By further example, the input device 132 can be accessible on an outer surface of the housing 110 for a user to provide the input. The input device 132 can be used to detect and interpret user inputs.

The head-mountable device 100 can include one or more output devices 138. For example, the output device 138 can include one or more speakers, haptic feedback devices, displays, and the like. By further example, the output device 138 can be exposed to an outer surface of the housing 110 for providing output to the user.

The head-mountable device can be provided with a flow channel that extends through at least a portion of the housing 110 thereof to provide cooling to components of the head-mountable device 100. As shown in FIGS. 2 and 3, a flow channel 144 can extend between one or more vents, such as from one or more inlet vents 140 to one or more outlet vents 142. While the inlet vents 140 are depicted at a bottom portion 124 of the housing 110 and the outlet vent 142 is depicted at the top portion 122 of the housing 110, it will be recognized that vents (i.e., inlets and/or outlets) and flow channels there between can be positioned at any portion of the head-mountable device 100. The outlet vents 142 can be provided at a location that will allow exiting air to exhaust to an environment that is not disruptive to the user. For example, the outlet vent(s) 142 can be provided at a location and in and orientation that directs hot air away from the user. Multiple flow channels 144 can be interconnected, such that one or more inlet vents 140 and/or one or more outlet vents 142 are connected to each other. One or more blowers (e.g., fans) can be operated to provide flow within the flow channel(s) 144 for cooling one or more components of the head-mountable device 100.

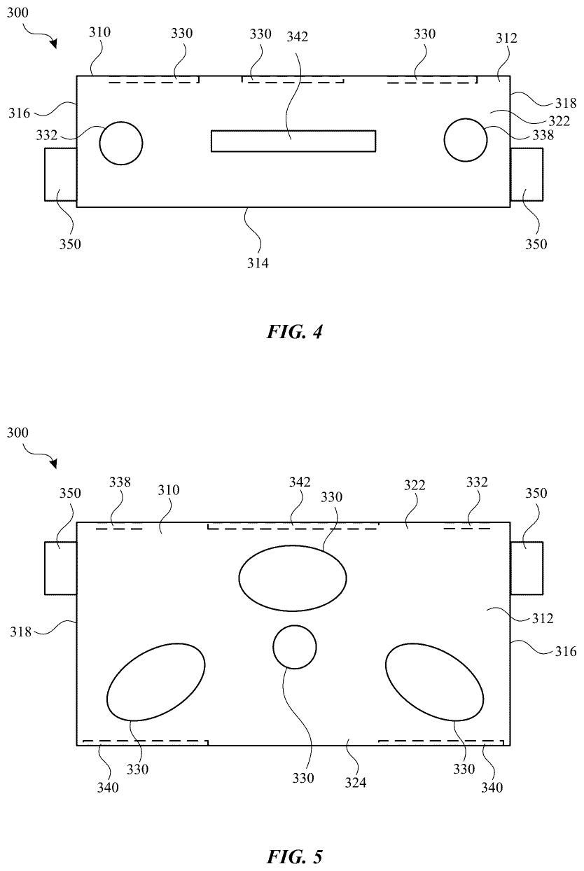

Referring now to FIGS. 4 and 5, a case can be used with a system of the present disclosure to support a head-mountable device during a capture operation.

According to some embodiments, for example as shown in FIGS. 4 and 5, a case 300 can include a body 310 that defines inner surfaces for engaging a head-mountable device and outer surfaces as an outer periphery of the case 300. The body 310 can be configured to receive, engage, and hold a head-mountable device.

The body 310 can include and/or define an outer portion 312 and an inner portion 314, opposite the outer portion 312. As used herein, an outer portion 312 of a case is a portion that faces away from the user and/or towards an external environment when coupled to a head-mountable device worn by a user. As used herein, an inner portion of a case is a portion that faces toward the user and/or away from the external environment when coupled to a head-mountable device worn by a user. The body 310 can further include and/or define a left portion 316 and a right portion 318, opposite the left portion 316. The body 310 can further include and/or define a top portion 322 and a bottom portion 324, opposite the top portion 322. As used herein, the terms “left,” “right,” “top,” and “bottom” each refer to the perspective of the user while wearing and/or operating a head-mountable device that is coupled to the case 300. It will be understood that such portions need not be planar and need not be distinctly defined relative to each other by edges and/or corners. As such, any given portion can transition to an adjacent portion. It will be understood that, while the body 310 is illustrated in FIGS. 4 and 5 with corners and edges, transitions from one portion to another may be gradual, curved, and the like. One or more features of the portions illustrated in FIGS. 4 and 5 may be provided at transitions between portions. Any number of portions can be provided. It will be recognized that opposing portions can engage corresponding opposing portions of a housing of a head-mountable device.

The case 300 can include one or more sensor openings 330 for providing a view for sensors of a head-mountable device. While sensor openings 330 are shown on the outer portion 312 of the body 310, it will be understood that sensor openings 330 can additionally or alternatively be provided at any portion of the case 300, for example at which corresponding sensors are provided, such as the top portion 322, the bottom portion 324, the left portion 316, the right portion 318, and/or the inner portion 314.

The case 300 can include one or more input openings 332 for providing access to input devices of a head-mountable device. While input openings 332 are shown on the top portion 322 of the body 310, it will be understood that input openings 332 can additionally or alternatively be provided at any portion of the case 300, for example at which corresponding input devices are provided, such as the bottom portion 324, the left portion 316, the right portion 318, the outer portion 312, and/or the inner portion 314.

The case 300 can include one or more output openings 338 for providing access to output devices of a head-mountable device. While output openings 338 are shown on the top portion 322 of the body 310, it will be understood that output openings 338 can additionally or alternatively be provided at any portion of the case 300, for example at which corresponding output devices are provided, such as the bottom portion 324, the left portion 316, the right portion 318, the outer portion 312, and/or the inner portion 314.

The case 300 can include one or more inlet openings 340 for providing flow to inlet vents of a head-mountable device. While inlet openings 340 are shown on the bottom portion 324 of the body 310, it will be understood that inlet openings 340 can additionally or alternatively be provided at any portion of the case 300, for example at which corresponding inlet vents are provided, such as the top portion 322, the left portion 316, the right portion 318, the outer portion 312, and/or the inner portion 314.

The case 300 can include one or more outlet openings 342 for providing flow from outlet vents of a head-mountable device. While outlet openings 342 are shown on the top portion 322 of the body 310, it will be understood that outlet openings 342 can additionally or alternatively be provided at any portion of the case 300, for example at which corresponding outlet vents are provided, such as the bottom portion 324, the left portion 316, the right portion 318, the outer portion 312, and/or the inner portion 314.

As shown in FIGS. 4 and 5, the case 300 can further include one or more case engagers 350 for providing coupling with other components of a system (sec FIGS. 1A-1C). The case engagers 350 can facilitate secure but releasable engagement to, for example, a head engager and/or an arm of a system. One or more of various mechanisms can be provided for the case engagers 350. For example, the case engagers 350 can include locks, latches, snaps, slides, channels, screws, clasps, threads, magnets, pins, an interference (e.g., friction) fit, knurl presses, bayoneting, fused materials, weaves, knits, braids, and/or combinations thereof to couple and/or secure to other components. While case engagers 350 are shown on the left portion 316 and the right portion 318 of the body 310, it will be understood that case engagers 350 can additionally or alternatively be provided at any portion of the case 300, such as the bottom portion 324, the top portion 322, the outer portion 312, and/or the inner portion 314. It will be understood that any number of case engagers 350 can be provided. Not every case engager 350 need be utilized at any given time to couple the case 300 to another component. For example, one or more systems can provide an ability to engage certain case engagers 350, and one or more other systems can provide an ability to engage other case engagers 350 and/or a different combination of case engagers 350. As such, multiple case engagers 350 can provide an ability for the case 300 to be used with different system components and/or with different systems.

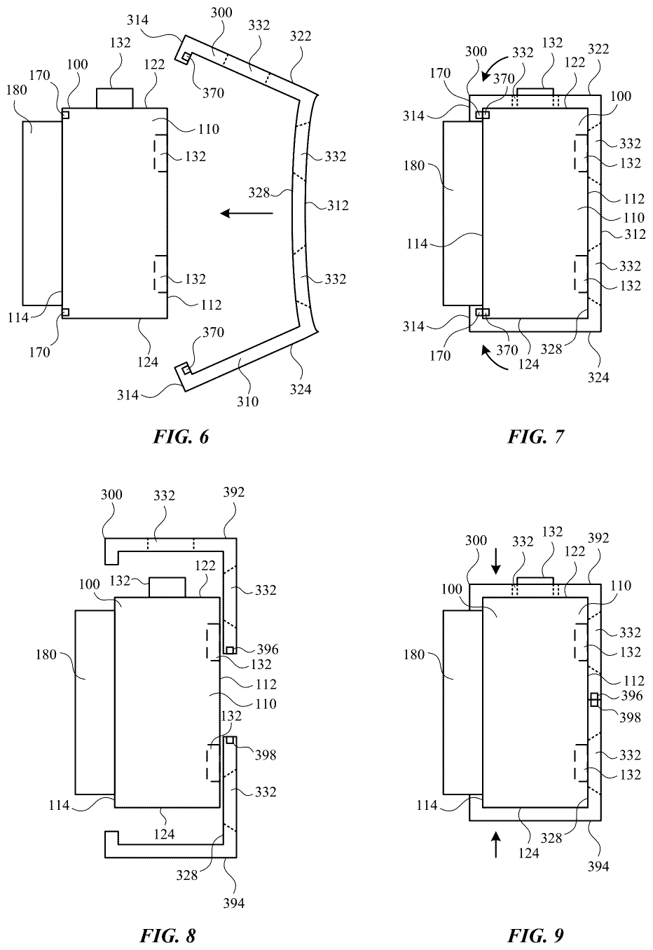

Referring now to FIGS. 6-9, a case can be provided with intimate engagement with a head-mountable device for secure and releasable coupling thereto.

In some embodiments, as shown in FIGS. 6 and 7, the body 310 of the case 300 can be flexible to facilitate engagement with the head-mountable device 100. For example, the body 310 can be of a material that provide sufficient flexibility to stretch around portions of the head-mountable device 100. For example, the body 310 can include rubber, polymer, foam, and the like to provide adequate flexibility. As shown in FIG. 6, the body 310 can be stretched so that the inner portion 314 separate (e.g., at least to be larger than a maximum cross-sectional dimension of the head-mountable device 100 and/or the housing 110) to receive at least a portion of the head-mountable device 100, such as the housing 110. As shown in FIG. 7, the body 310 can have elastic properties, such that the body 310 is biased to a relaxed configuration in which an inner surface 328 of the case 300 conforms to contours of the head-mountable device 100, such as the housing 110.

When engaged, the inner surface 328 of the case 300 can conform to an outer surface of the head-mountable device 100, such as the housing 110. For example, the inner surface 328 can be the same, similar, and/or complementary shape, size, dimension, or other characteristic to conform to the head-mountable device 100, such as at the housing 110. It will be understood that such complementary features can include matching structural features of one to voids of the other, such that minimal open space is provided between the case 300 and the head-mountable device 100. Accordingly, movement of one in any direction can result in movement of the other while they are in intimate engagement.

In some embodiments, the case 300 can extend about at least half of a total volume of the housing 110. For example, the body 310 can surround and extend beyond portions of the head-mountable device 100 that define a maximum outer cross-sectional dimension. By further example, the body 310 can cover at least half of a total outer surface area of the housing 110. By further example, the body 310 can extend beyond an equator of the head-mountable device 100. As such, the case 300 can be secured to the head-mountable device 100 until it is expanded or otherwise stretched to disengage the head-mountable device 100. For example, while engaged together, forces can be transmitted between the case 300 and the head-mountable device 100, such that the two move as a single unit. In some embodiments, the case 300 can optionally extend to but need not cover portions of the face engager 180. In particular, the face engager 180 can remain exposed so that it can directly contact a face of the user wearing the head-mountable device 100.

In some embodiments, the case 300 can include one or more case engagers 370, and the head-mountable device 100 can include one or more head-mountable device (HMD) engagers 170. The case engagers 370 and/or the HMD engagers 170 can include locks, latches, snaps, slides, channels, screws, clasps, threads, magnets, pins, an interference (e.g., friction) fit, knurl presses, bayoneting, fused materials, weaves, knits, braids, and/or combinations thereof to couple and/or secure the parts together. The case engagers 370 and/or the HMD engagers 170 can remain engaged until released, such as by a user with a manual input. It will be understood that the engagers need not be provided, particularly where the shape of the case engages the head-mountable device 100.

In some embodiments, as shown in FIGS. 8 and 9, the body 310 of the case 300 can include separable parts to facilitate engagement with the head-mountable device 100. For example, the body 310 can include a first segment 392 and a second segment 394. The case can be of a material that provide sufficient rigidity to secure portions of the head-mountable device 100. For example, the body 310 can include plastic, metal, ceramic, and the like to provide adequate rigidity. As shown in FIG. 8, the body 310 can be separated between the first segment 392 and the second segment 394 to receive at least a portion of the head-mountable device 100, such as the housing 110.

In some embodiments, the first segment 392 can include one or more first engagers 396, and the second segment 394 can include one or more second engagers 398. The first engagers 396 and/or the second engagers 398 can include locks, latches, snaps, slides, channels, screws, clasps, threads, magnets, pins, an interference (e.g., friction) fit, knurl presses, bayoneting, fused materials, weaves, knits, braids, and/or combinations thereof to couple and/or secure the parts together. The first engagers 396 and/or the second engagers 398 can remain engaged until released, such as by a user with a manual input.

When engaged, the inner surface 328 of the case 300 across each of the first segment 392 and the second segment 394 can conform to an outer surface of the head-mountable device 100, such as the housing 110. For example, the inner surface 328 across each of the first segment 392 and the second segment 394 can be the same, similar, and/or complementary shape, size, dimension, or other characteristic to conform to corresponding regions of the head-mountable device 100, such as at the housing 110. It will be understood that such complementary features can include matching structural features of one to voids of the other, such that minimal open space is provided between the case 300 and the head-mountable device 100. Accordingly, movement of one in any direction can result in movement of the other while they are in intimate engagement.

In some embodiments, the assembly of the first segment 392 and the second segment 394 can extend about at least half of a total volume of the housing 110. For example, the first segment 392 and the second segment 394 can surround and extend beyond portions of the head-mountable device 100 that define a maximum outer cross-sectional dimension. By further example, the first segment 392 and the second segment 394 can cover at least half of a total outer surface area of the housing 110. By further example, the first segment 392 and the second segment 394 can extend beyond an equator of the head-mountable device 100. As such, the case 300 can be secured to the head-mountable device 100 until it is separated to disengage the head-mountable device 100. For example, while engaged together, forces can be transmitted between the case 300 and the head-mountable device 100, such that the two move as a single unit. In some embodiments, the case 300 can optionally extend to but need not cover portions of the face engager 180. In particular, the face engager 180 can remain exposed so that it can directly contact a face of the user wearing the head-mountable device 100.

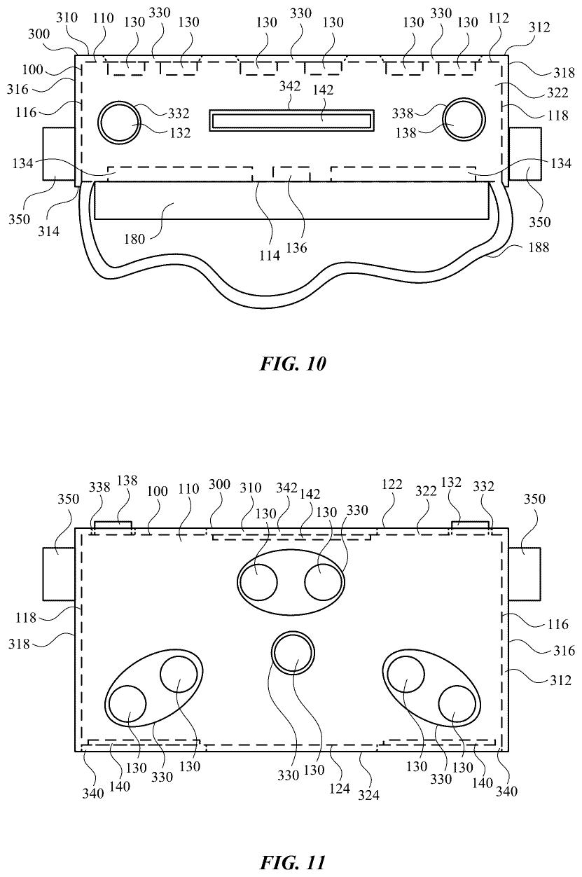

Referring now to FIGS. 10 and 11, a case can coupled to a head-mountable device to support operations thereof.

According to some embodiments, for example as shown in FIGS. 10 and 11, a case 300 can include a body 310 that defines inner surfaces for engaging a head-mountable device and outer surfaces as an outer periphery of the case 300. The body 310 can be configured to receive, engage, and hold a head-mountable device.

The body 310 of the case 300 can overlap corresponding portions of the housing 110 of the head-mountable device 100. For example, the outer portion 312 of the case 300 can cover at least some of the outer portion 112 of the head-mountable device 100. By further example, the left portion 316 of the case 300 can cover at least some of the left portion 116 of the head-mountable device 100. By further example, the right portion 318 of the case 300 can cover at least some of the right portion 118 of the head-mountable device 100. By further example, the top portion 322 of the case 300 can cover at least some of the top portion 122 of the head-mountable device 100. By further example, the bottom portion 324 of the case 300 can cover at least some of the bottom portion 124 of the head-mountable device 100. By further example, the inner portion 314 of the case 300 can cover at least some of the inner portion 114 of the head-mountable device 100.

The one or more sensor openings 330 of the case 300 can overlap and provide a view for sensors 130 of the head-mountable device 100. As shown in FIG. 11, one or more sensors 130 can be positioned at any given sensor opening 330. In some embodiments, the sensor openings 330 can define a shape that facilitates operation of the sensors 130. For example, the sensor openings 330 can include a taper, expanding size, chamfer, or the like to provide a corresponding field of view to the sensors 130. Where the sensors 130 detect within a range that is represented by an expanding field of view, the sensor openings 330 can likewise expand in cross-sectional dimension as they extend from the inner surface 328 of the body 310.

The one or more input openings 332 of the case 300 can overlap and provide access to input devices 132 of the head-mountable device 100. For example, the input devices 132 can optionally extend through and/or protrude beyond the input openings 332 or otherwise be accessible from outside of the case 300. The one or more output openings 338 of the case 300 can overlap and provide access to output devices 138 of the head-mountable device 100. For example, the output devices 138 can optionally extend through and/or protrude beyond the input openings 332 or otherwise be accessible from outside of the case 300.

The one or more inlet openings 340 of the case 300 can overlap and provide flow to inlet vents 140 of the head-mountable device 100. The inlet openings 340 can be larger than the inlet vents 140, so as to not block the flow thereto. The one or more outlet openings 342 of the case 300 can overlap and provide flow from outlet vents 142 of the head-mountable device 100. The outlet openings 342 can be larger than the outlet vents 142, so as to not block the flow therefrom.

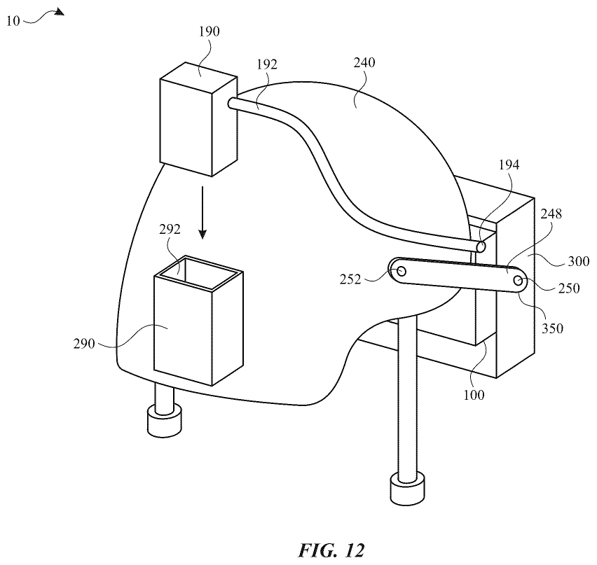

Referring now to FIG. 12, a system can include features for supporting accessories for the head-mountable device.

As shown in FIG. 12, the system 10 can include the head engager 240, which can include a holder 290 for receiving an accessory device 190. The accessory device 190 can be attachable, removable, and/or exchangeable to provide to the head-mountable device 100 a variety of different components and functions to achieve the results that are desired by a user. The accessory device 190 can be separate from but connectable to the head-mountable device 100. The head-mountable device 100 can include one or more HMD connectors 194 for mechanically and operably (e.g., communicatively) connecting to the accessory device 190 via an accessory connector 192.

In some embodiments, the accessory device 190 can be a device that can be held or carried by a user. In some embodiments, the accessory device 190 can be a wearable device that is worn optionally near the head-mountable device 100. The accessory device 190 can be worn on a head, neck, ear, shoulders, and/or other portion of the user and/or the user's clothing (e.g., pocket). The accessory device 190 can include a securement element to secure the accessory device 190 to or near a user.

To maintain the accessory device 190 in connection with the head-mountable device 100, the head engager 240 or another component of the system can include a holder 290. The holder 290 can include a receptacle 292 for receiving the accessory device 190. In some embodiments, the holder 290 can securely retain the accessory device 190 until release by a user. For example, the holder 290 can include one or more engagers for maintaining a position and/or orientation of the accessory device 190 with respect to the holder 290 until release.

As used herein, “accessory” can refer to a characteristic that allows an item, such as an accessory device, to be connected, installed, removed, swapped, and/or exchanged by a user in conjunction with a head-mountable device. It will be understood that the head-mountable device can be operable with or without use of the accessory device and that the accessory device can provide additional functionality to the head-mountable device when installed. Connection of an accessory device with a head-mountable device can be performed and reversed, followed by disconnection and connection of another accessory device with the same head-mountable device or another head-mountable device with the same accessory device. As such, multiple accessory devices can be exchangeable with each other with respect to a given head-mountable device. Further, multiple head-mountable devices can be exchangeable with each other with respect to a given accessory device.

As further shown in FIG. 12, the case 300 can be adjustably coupled to the head engager 240 and/or one or more other components of the system 10 by a coupler 248. The coupler 248 can include one or more adjusters 252 that can be operated to change a position and/or orientation of the case 300 with respect to the head engager 240 and/or one or more other components of the system 10. The coupler 248 can further include one or more coupler engagers 254 securely and releasably engaging the case engagers 350 of the case 300. As such, the case 300 can be held in a consistent position and/or orientation until adjusted as desired. Such adjustments can allow the case 300 to be set to a new position and/or orientation so that the head-mountable device 100 is in a preferred position and/or orientation with respect to the user wearing the head engager 240.

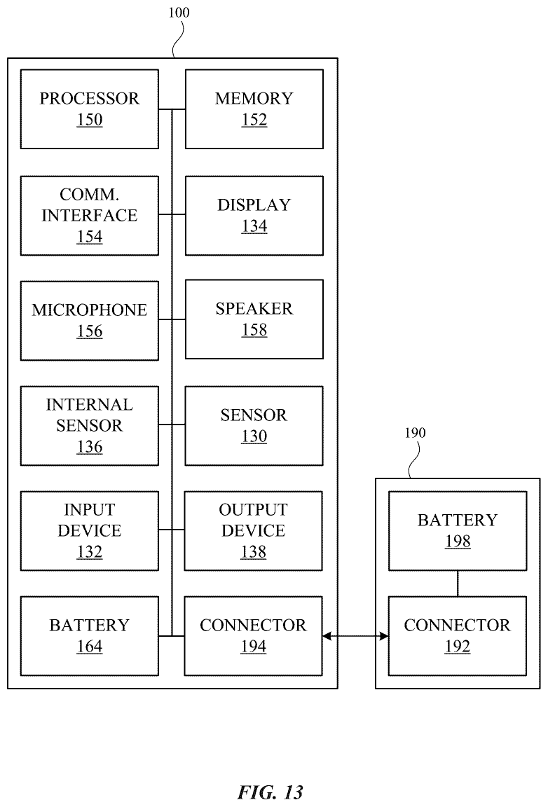

FIG. 13 illustrates a block diagram of a system including a head-mountable device and one or more accessory devices, in accordance with some embodiments of the present disclosure. It will be appreciated that components described herein can be provided on either or both of a head-mountable device and/or an accessory device. In some embodiments, components are provided by an accessory device and/or an external device instead of a head-mountable device to reduce redundancy and increase customization based on a selection of accessory devices.

As shown in FIG. 13, the head-mountable device 100 can include a processor 150 with one or more processing units that include or are configured to access a memory 152 having instructions stored thereon. The instructions or computer programs may be configured to perform one or more of the operations or functions described with respect to the head-mountable device 100. The processor 150 can be implemented as any electronic device capable of processing, receiving, or transmitting data or instructions. For example, the processor 150 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements. The memory 152 can store electronic data that can be used by the head-mountable device 100. For example, the memory 152 can store electrical data or content such as, for example, audio and video files, documents and applications, device settings and user preferences, timing and control signals or data for the various modules, data structures or databases, and so on. The memory 152 can be configured as any type of memory. By way of example only, the memory 152 can be implemented as random access memory, read-only memory, Flash memory, removable memory, or other types of storage elements, or combinations of such devices.

The head-mountable device 100 can include a sensor 130 for performing one or more detections with respect to an environment. In some embodiments, the sensor 130 can be a camera operable to capture a view of an environment external to the head-mountable device 100. The sensor 130 can include an optical sensor, such as a photodiode or a photodiode array. Additionally or alternatively, the sensor 130 can include one or more of various types of optical sensors that are arranged in various configurations for detecting user inputs described herein. The sensor 130 may be configured to capture an image of a scene or subject located within a field-of-view of the sensor 130. The image may be stored in a digital file in accordance with any one of a number of digital formats. In some embodiments, the head-mountable device 100 includes a camera, which includes an image sensor formed from a charge-coupled device (CCD) and/or a complementary metal-oxide-semiconductor (CMOS) device, a photovoltaic cell, a photo resistive component, a laser scanner, and the like. It will be recognized that a camera can include other motion sensing devices.

In some embodiments, the sensor 130 can include an environmental sensor that detects one or more conditions in an environment of the head-mountable device 100. For example, an environmental sensor can include an imaging device, a thermal sensor, a proximity sensor, a motion sensor, a humidity sensor, a chemical sensor, a light sensor, and/or a UV sensor. An environmental sensor can be configured to sense substantially any type of characteristic such as, but not limited to, images, pressure, light, touch, force, temperature, position, motion, and so on. By further example, the environmental sensor may be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. The sensor can be used to sense ambient conditions in a neighboring environment.

The head-mountable device 100 can further include a display 134 for displaying visual information for a user. The display 134 can provide visual (e.g., image or video) output. The display 134 can be or include an opaque, transparent, and/or translucent display. A transparent or translucent display 134 may have a medium through which light representative of images is directed to a user's eyes. The display 134 may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The head-mountable device 100 can further include the internal sensor 136 and/or the sensor 130, as discussed herein. The internal sensor 136 can include one or more user sensors for tracking features of the user using or wearing the head-mountable device 100. For example, a user sensor can perform facial feature detection, facial movement detection, facial recognition, eye tracking, user mood detection, user emotion detection, voice detection, etc. Such eye tracking may be used to determine a location of information to be displayed on the display 134 and/or a portion (e.g., object) of a view to be analyzed by the head-mountable device 100. By further example, the user sensor can be a bio-sensor for tracking biometric characteristics, such as health and activity metrics. The user sensor can include a bio-sensor that is configured to measure biometrics such as electrocardiographic (ECG) characteristics, galvanic skin resistance, and other electrical properties of the user's body. Additionally or alternatively, a bio-sensor can be configured to measure body temperature, exposure to UV radiation, and other health-related information.

The head-mountable device 100 can include an input device 132 and/or an output device 138, which can include any suitable component for receiving inputs and/or providing outputs to a user wearing the head-mountable device and/or another user. The input device 132 and/or the output device 138 can include buttons, keys, or another feature that can act as a keyboard for operation by the user.

The head-mountable device 100 can include communications interface 154 for communicating with one or more servers or other devices using any suitable communications protocol. For example, communications interface 154 can support Wi-Fi (e.g., a 802.11 protocol), Ethernet, Bluetooth, high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. A communications interface 154 can also include an antenna for transmitting and receiving electromagnetic signals.

The head-mountable device 100 can include a battery 164, which can charge and/or power components of the head-mountable device 100. The battery 164 can also charge and/or power components connected to the head-mountable device 100.

The head-mountable device 100 can include the HMD connectors 194 and the accessory device 190 can include the accessory connector 192 for establishing a communication link between the head-mountable device 100 and the accessory device 190.

The accessory device 190 can be controlled at least in part by the processor 150 of the head-mountable device 100. For example, while the accessory device 190 is connected to the head-mountable device 100, the processor 150 of the head-mountable device 100 can operably connect to and/or control one or more components of the accessory device 190 via the communication link provided by the HMD connectors 194 and/or the accessory connectors 192.

In some embodiments, the accessory device 190 can operate as a power source for the head-mountable device 100. By providing power with a removable accessory device, the user can select such an accessory device according to anticipated power needs. The accessory device 190 can include a battery 198 that is used to store and provide power to the head-mountable device 100 and/or components of the accessory device 190. Optionally, the accessory device 190 can recharge the battery 164 of the head-mountable device 100, for example, by directing power from the battery 198 across the communication link provided by the HMD connectors 194 and/or the accessory connectors 192. Other pathways are contemplated, such as another link or wireless charging. The battery 198 can be a replaceable battery, a rechargeable battery.

Further examples of accessory components that can be included with and/or provided by the accessory device 190 include speakers, cameras, microphones, sensors, bio-sensors, user sensors, display drivers, and/or components for receiving input from a user, providing output to a user, and/or performing other functions. It will be understood that any components can be provided with the accessory device 190 and provided with a communication link with the head-mountable device 100. It will be further understood that any number of accessory devices 190 can be provided.

In some embodiments, the head-mountable device 100 can alter one or more parameters of its operations based on the presence, absence, or other condition of the system 10. For example, when the head-mountable device 100 is coupled to the system (e.g., via the case), the head-mountable device 100 may focus its operations on the detections facilitated by the system 10. By further example, the head-mountable device 100 may allocate greater processing power to the operations of the sensors 130 while reducing other operations, such as output parameters of the display. Accordingly, the head-mountable device 100 can detect the presence of the case and adjust its operation to focus on the functions that are facilitated by the case and/or other components of the system 10, such as stabilization of image capture.

Accordingly, embodiments of the present disclosure provide systems and devices with stabilization features that support a head-mountable device to both facilitate and enhance movement during capture of images. The systems can include a case that engages the head-mountable device and provides a view to an external environment. The support provided by the system can provide the user wearing the head-mountable device with a wide range of movement (e.g., pan and tilt) while also guiding movement within the range.

Various examples of aspects of the disclosure are described below as clauses for convenience. These are provided as examples, and do not limit the subject technology.

Clause A: a system for stabilizing a head-mountable device, the system comprising: a base; an arm pivotable about a pivot and with respect to the base; a counterweight on a side of the pivot opposite the arm; and a case for receiving the head-mountable device, the case being on an end of the arm that is opposite the pivot, the case defining an opening to provide the head-mountable device with a view to an external environment.

Clause B: a system for receiving a head-mountable device, the system comprising: a case for receiving the head-mountable device, the case comprising: a body defining an opening to provide the head-mountable device with a view to an external environment; and a case engager; and a head engager configured to secure to a head and releasably engage the case at the case engager, wherein the head engager is configured to attach to a pivotable arm, wherein the case is adjustable with respect to the head engager to align the head-mountable device with respect to a face.

Clause C: a case for receiving a head-mountable device, the case comprising: a body defining an upper portion, a lower portion opposite the upper portion, and an outer portion; a sensor opening extending through the outer portion, an inlet opening extending through the lower portion; and an outlet opening extending through the upper portion, wherein, when the case receives the head-mountable device: the sensor opening is positioned to overlap a sensor of the head-mountable device; the inlet opening is positioned to overlap an inlet vent of the head-mountable device; and the outlet opening is positioned to overlap an outlet vent of the head-mountable device.

One or more of the above clauses can include one or more of the features described below. It is noted that any of the following clauses may be combined in any combination with each other, and placed into a respective independent clause, e.g., Clause A, B, or C.

Clause 1: a head engager coupling the arm to the case, wherein the head engager is configured to secure to a head and align the head-mountable device with a face.

Clause 2: the arm is coupled to a lower portion of the head engager that is on a side of the head engager that is opposite the arm and below the case.

Clause 3: a post between the base and the arm, wherein the post is pivotable about a post pivot and with respect to the base.

Clause 4: wheels at the base.

Clause 5: a handle rigidly coupled to the case, wherein the opening is on an outer portion of the case, the outer portion being configured to be positioned on a side of the head-mountable device that faces away from the handle.

Clause 6: a holder coupled to the head engager and configured to removably receive an accessory device operably connected to the head-mountable device.

Clause 7: a handle rigidly coupled to the case and the head engager wherein an outer portion of the case defining the opening is configured to be positioned on a side of the head-mountable device that faces away from the handle.

Clause 8: the case defines additional openings to provide access to an input device and an output device of the head-mountable device.

Clause 9: the inlet opening is a first inlet opening; the inlet vent is a first inlet vent; and the case further comprises a second inlet opening extending through the lower portion, wherein, when the case receives the head-mountable device, the inlet opening is positioned to overlap a second inlet vent of the head-mountable device.

Clause 10: the sensor opening increases in cross-sectional dimension as it extends from an inner surface of the case.

Clause 11: the sensor opening is one of multiple sensor openings, wherein each of the sensor openings is configured to overlap multiple sensors of the head-mountable device.

Clause 12: a case engager configured to releasably and adjustably secure the case at one of multiple positions and orientations with respect to a head engager.

Clause 13: an input opening on the upper portion of the body, wherein, when the case receives the head-mountable device, the inlet opening is positioned to receive an input device of the head-mountable device extending through the inlet opening.

Clause 14: an output opening on the upper portion of the body, wherein, when the case receives the head-mountable device, the output opening is positioned to overlap an output device of the head-mountable device.

Clause 15: when the case receives the head-mountable device, an inner surface of the body is configured to conform to an outer surface of the head-mountable device.

Clause 16: the body is flexible, such that inner portions of the body are adjustable to be larger than a maximum cross-sectional dimension of the head-mountable device.

Clause 17: the case comprises: a first segment comprising a first engager; and a second segment comprising a second engager, wherein the first engager and the second engager are configured to releasably secure the first segment to the second segment.

A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

In contrast, a computer-generated reality (CGR) environment refers to a wholly or partially simulated environment that people sense and/or interact with via an electronic system.

In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations, (e.g., for accessibility reasons), adjustments to characteristic(s) of virtual object(s) in a CGR environment may be made in response to representations of physical motions (e.g., vocal commands).

A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects.

Examples of CGR include virtual reality and mixed reality.

A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end.

In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.

Examples of mixed realities include augmented reality and augmented virtuality.

An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment.

An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

An augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

There are many different types of electronic systems that enable a person to sense and/or interact with various CGR environments. Examples include head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

As described above, one aspect of the present technology may include the gathering and use of data available from various sources. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim clement is to be construed under the provisions of 35 U.S.C. § 112, sixth paragraph, unless the clement is expressly recited using the phrase “means for” or, in the case of a method claim, the clement is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A system for stabilizing a head-mountable device, the system comprising:
a base;
an arm pivotable about a pivot and with respect to the base;
a counterweight on a side of the pivot opposite the arm; and
a case for receiving the head-mountable device, the case being on an end of the arm that is opposite the pivot, the case defining an opening to provide the head-mountable device with a view to an external environment.

2. The system of claim 1, further comprising a head engager coupling the arm to the case, wherein the head engager is configured to secure to a head and align the head-mountable device with a face.

3. The system of claim 2, wherein the arm is coupled to a lower portion of the head engager that is on a side of the head engager that is opposite the arm and below the case.

4. The system of claim 1, further comprising a post between the base and the arm, wherein the post is pivotable about a post pivot and with respect to the base.

5. The system of claim 1, further comprising wheels at the base.

6. The system of claim 1, further comprising a handle rigidly coupled to the case, wherein the opening is on an outer portion of the case, the outer portion being configured to be positioned on a side of the head-mountable device that faces away from the handle.

7. A system for receiving a head-mountable device, the system comprising:
a case for receiving the head-mountable device, the case comprising:
a body defining an opening to provide the head-mountable device with a view to an external environment; and
a case engager; and
a head engager configured to secure to a head and releasably engage the case at the case engager, wherein the head engager is configured to attach to a pivotable arm, wherein the case is adjustable with respect to the head engager to align the head-mountable device with respect to a face.

8. The system of claim 7, further comprising a holder coupled to the head engager and configured to removably receive an accessory device operably connected to the head-mountable device.

9. The system of claim 7, further comprising a handle rigidly coupled to the case and the head engager wherein an outer portion of the case defining the opening is configured to be positioned on a side of the head-mountable device that faces away from the handle.

10. The system of claim 7, wherein the case defines additional openings to provide access to an input device and an output device of the head-mountable device.

11. A case for receiving a head-mountable device, the case comprising:
a body defining an upper portion, a lower portion opposite the upper portion, and an outer portion;
a sensor opening extending through the outer portion, an inlet opening extending through the lower portion; and
an outlet opening extending through the upper portion,
wherein, when the case receives the head-mountable device:
the sensor opening is positioned to overlap a sensor of the head-mountable device;
the inlet opening is positioned to overlap an inlet vent of the head-mountable device; and
the outlet opening is positioned to overlap an outlet vent of the head-mountable device.

12. The case of claim 11, wherein:
the inlet opening is a first inlet opening;
the inlet vent is a first inlet vent; and
the case further comprises a second inlet opening extending through the lower portion, wherein, when the case receives the head-mountable device, the inlet opening is positioned to overlap a second inlet vent of the head-mountable device.

13. The case of claim 11, wherein the sensor opening increases in cross-sectional dimension as it extends from an inner surface of the case.

14. The case of claim 11, wherein the sensor opening is one of multiple sensor openings, wherein each of the sensor openings is configured to overlap multiple sensors of the head-mountable device.

15. The case of claim 11, further comprising a case engager configured to releasably and adjustably secure the case at one of multiple positions and orientations with respect to a head engager.

16. The case of claim 11, further comprising an input opening on the upper portion of the body, wherein, when the case receives the head-mountable device, the inlet opening is positioned to receive an input device of the head-mountable device extending through the inlet opening.

17. The case of claim 11, further comprising an output opening on the upper portion of the body, wherein, when the case receives the head-mountable device, the output opening is positioned to overlap an output device of the head-mountable device.

18. The case of claim 11, wherein, when the case receives the head-mountable device, an inner surface of the body is configured to conform to an outer surface of the head-mountable device.

19. The case of claim 11, wherein the body is flexible, such that inner portions of the body are adjustable to be larger than a maximum cross-sectional dimension of the head-mountable device.

20. The case of claim 11. wherein the case comprises:
a first segment comprising a first engager; and
a second segment comprising a second engager, wherein the first engager and the second engager are configured to releasably secure the first segment to the second segment.
